(19) United States
(12) Patent Application Publication
(10) Pub. No.: US 2025/0370320 A1
(43) Pub. Date: Dec. 4, 2025

(54) PROJECTION IMAGE ADJUSTMENT APPARATUS, IMAGE PROJECTION APPARATUS, AND IMAGE PROJECTION SYSTEM

(71) Applicants: Yuto AKIBA, Kanagawa (JP); Tomoya FUJII, Kanagawa (JP); Tomokazu NAMIKI, Kanagawa (JP); Kazuhiro FUJITA, Tokyo (JP)

(72) Inventors: Yuto AKIBA, Kanagawa (JP); Tomoya FUJII, Kanagawa (JP); Tomokazu NAMIKI, Kanagawa (JP); Kazuhiro FUJITA, Tokyo (JP)

(21) Appl. No.: 19/215,367

(22) Filed: May 22, 2025

(30) Foreign Application Priority Data
May 31, 2024 (JP) 2024-089516
Jan. 31, 2025 (JP) 2025-014989

(51) Int. Cl. G03B 21/14; F16M 11/20; F16M 11/24; F16M 11/42

(52) U.S. Cl. CPC G03B 21/145; F16M 11/2064; F16M 11/24; F16M 11/42

(57) ABSTRACT

A projection image adjustment apparatus includes a base attached to a projection apparatus to project a light in a projection direction; a mover to move the base in a movement direction; and a rotator including a mount to mount the base attached to the projection apparatus; and an imaginary rotation axis perpendicular to a plane including the movement direction and the projection direction. The mount is rotatable about the imaginary rotation axis. The imaginary rotation axis passes through a region of the projection apparatus mounted on the mount via the base.

### CROSS-REFERENCE TO RELATED APPLICATIONS

This patent application is based on and claims priority pursuant to 35 U.S.C. § 119(a) to Japanese Patent Application No. 2024-089516, filed on May 31, 2024 and Japanese Patent Application No. 2025-014989, filed on Jan. 31, 2025, in the Japan Patent Office, the entire disclosure of each are hereby incorporated by reference herein.

### BACKGROUND

### Technical Field

The present disclosure relates to a projection image adjustment apparatus, an image projection apparatus, and an image projection system.

### Related Art

A projection image adjustment apparatus includes a base unit on which a projection apparatus is mountable, and a moving unit that moves the position of the base unit in a predetermined movement direction.

### SUMMARY

The present disclosure described herein provides a projection image adjustment apparatus including a base attached to a projection apparatus to project a light in a projection direction; a mover to move the base in a movement direction; and a rotator including a mount to mount the base attached to the projection apparatus; and an imaginary rotation axis perpendicular to a plane including the movement direction and the projection direction. The mount is rotatable about the imaginary rotation axis. The imaginary rotation axis passes through a region of the projection apparatus mounted on the mount via the base.

The present disclosure described herein provides an image projection apparatus including: a projector to emit light in a projection direction to project a projection image onto a projection surface. The projector has a throw ratio greater than or equal to 0.18 and less than or equal to 0.5.

The present disclosure described herein provides an image projection system includes an image projection apparatus to emit light in a projection direction to project a projection image onto a projection surface; and the projection image adjustment apparatus to adjust the image projection apparatus to adjust the projection image on the projection surface. The image projection apparatus has a throw ratio greater than or equal to 0.18 and less than or equal to 0.5.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a projector according to an embodiment of the present disclosure;

FIG. 2 is a right side view of the projector illustrated in FIG. 1;

FIG. 3 is a table illustrating the relationship between the projection distance and the screen size of the projector illustrated in FIG. 1;

FIG. 4 is a perspective view of an image projection system including a carriage on which the projector illustrated in FIG. 1 is mounted;

FIG. 5 is a perspective view of the image projection system when the projector illustrated in FIG. 1 and a bracket are separated from the carriage illustrated in FIG. 4;

FIG. 6 is an explanatory diagram illustrating an example correspondence relationship between heights of the projector illustrated in FIG. 1 and sizes of an image to be projected onto a floor surface;

FIG. 7 is an explanatory diagram illustrating the height of the projector illustrated in FIG. 1 when a projection image corresponding to a small display size is projected onto the floor surface;

FIG. 8 is a graph plotting, for each throw ratio (TR) of the projector illustrated in FIG. 1, the relationship between the screen size and the projection distance (height) for projection onto the floor surface;

FIG. 9 is a perspective view of the bracket on which the projector illustrated in FIG. 1 is mountable;

FIG. 10 is an explanatory diagram illustrating the movement of an elevating mechanism according to the embodiment of the present disclosure;

FIG. 11 is an explanatory diagram illustrating the configuration of a main portion of the elevating mechanism illustrated in FIG. 10;

FIG. 12 is an explanatory diagram illustrating a shaft clamp of the elevating mechanism illustrated in FIG. 10;

FIG. 13 is an explanatory diagram illustrating the movement of a tilt adjustment mechanism according to the embodiment of the present disclosure;

FIG. 14 is an explanatory diagram illustrating the configuration of a fixing portion of the tilt adjustment mechanism illustrated in FIG. 13;

FIG. 15 is an explanatory diagram illustrating a change in the projection direction of the projector illustrated in FIG. 1 using the tilt adjustment mechanism illustrated in FIG. 13;

FIG. 16 is an explanatory diagram illustrating a swivel mechanism according to the embodiment of the present disclosure;

FIG. 17 is an explanatory diagram illustrating the movement of the swivel mechanism illustrated FIG. 16; and

FIG. 18 is an explanatory diagram of a change in the rotation angle of a projection image as the carriage illustrated in FIG. 1 is rotated.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

For example, a mounting device (projection image adjustment apparatus) includes a mounting unit (base unit) for mounting a projector (projection apparatus) and an elevating unit (moving unit) that moves the position of the mounting unit in the direction of gravity. The elevating unit is coupled to the mounting unit through a pivot unit provided at an upper end of the elevating unit. The pivot unit is configured to be pivotable about a rotation axis extending in a horizontal direction orthogonal to a projection direction of the projector mounted on the mounting unit. By rotating the pivot unit about the rotation axis, the projection direction of the projector can be changed upward or downward, and an image projected from the projector can be projected onto a horizontal surface or a vertical surface.

However, the projection image adjustment apparatus of the related art has a problem in that it is difficult to adjust a projection image to be projected onto a projection surface. According to one aspect of the present disclosure, it is possible to provide a projection image adjustment apparatus that facilitates adjustment of a projection image to be projected onto a projection surface.

An image projection system according to an embodiment of the present disclosure will be described hereinafter.

The image projection system according to the present embodiment includes a projector, which is an image projection apparatus serving as a projection apparatus, and a carriage, which is a projection image adjustment apparatus that enables adjustment of a projection image to be projected onto a projection surface by the projector.

First, the basic configuration of the projector according to the present embodiment will be described.

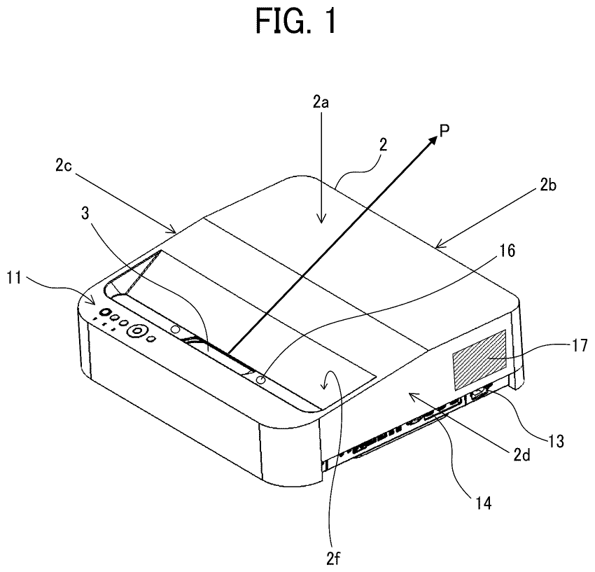

FIG. 1 is a perspective view of a projector 1 according to the present embodiment.

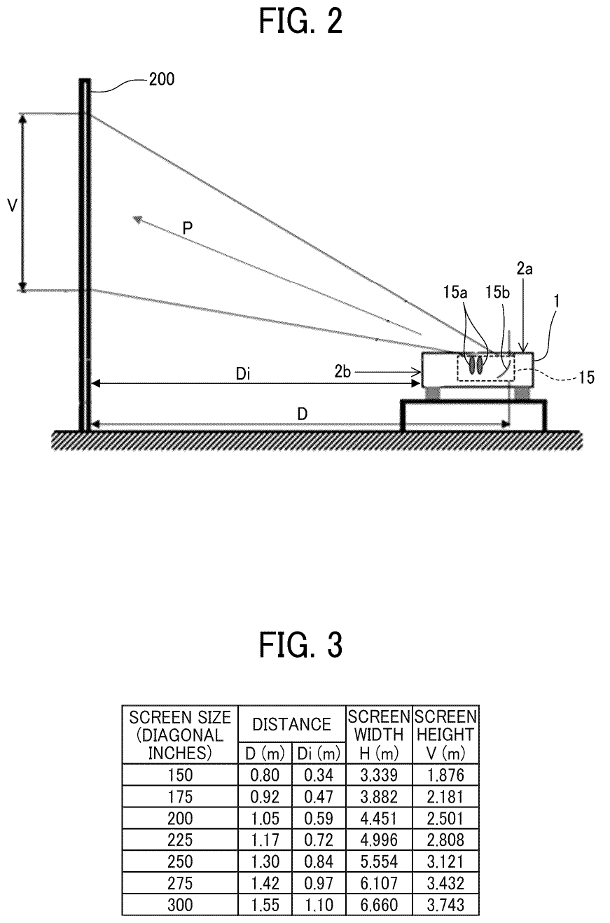

FIG. 2 is a right side view of the projector 1 and illustrates an example relationship between a projection distance D and a screen size.

FIGS. 1 and 2 illustrate a mode of use in which an image is projected onto a screen 200 serving as a projection surface, which is a vertical surface. In this mode of use, a top plate 2a, which forms an upper surface of a housing 2 of the projector 1, has an operation unit 11 including, for example, operation buttons for a user to give various instructions to operate the projector 1.

FIG. 3 is a table illustrating the relationship between the projection distance and the screen size of the projector 1.

As illustrated in FIG. 3, by adjusting the projection distance D within a range of 0.8 m to 1.55 m, the screen size (diagonal size) can be changed from 150 inches to 300 inches, i.e., nearly doubled. Since the projector 1 has depth (the width of the projector 1 in the left-right direction in FIG. 2), a distance Di between the screen 200 and the projector 1 may be adjusted. In the example illustrated in FIG. 3, by setting the value of the distance Di in a range of 0.34 m to 1.1 m, the screen size can be set as desired in the range described above.

The values illustrated in FIG. 3 are an example, and the adjustment range of the screen size is further increased in a case where a projection can be performed with the desired quality maintained when the projector 1 is brought close to the screen 200 until the projector 1 comes into contact with the screen 200.

Furthermore, it goes without saying that a larger screen size can be achieved in a case where the desired image quality can be maintained when the projection distance D is set to a value greater than 1.1 m.

The housing 2 incorporates a projection optical system 15, and projection light from the projection optical system 15 is projected from a projection window 3. The projection optical system 15 includes a lens group 15a and a concave mirror 15b. FIG. 2 illustrates the configuration of the projection optical system 15 as viewed from the side.

The projection light projected from the projection window 3 is focused by the lens group 15a of the projection optical system 15, reflected by the concave mirror 15b, narrowed into a beam of light, and then exits from the projection window 3. The projection light spreads after exiting from the projection window 3, and forms an image on a desired image plane. The top plate 2a has a recess 2f to prevent the obstruction of the projection light exiting from the projection window 3. The projection optical system 15 in the housing 2 also includes components such as a focus drive ring to adjust the focus of a projection image V to be projected and displayed on the projection surface (i.e., the screen 200). The focus drive ring has a motor-driven electric focus function. Because the throw ratio TR is very small, the size of the projection image V can be easily adjusted for enlargement or reduction by changing the projection distance D.

A right side plate 2d forms a right side surface of the housing 2 and has, for example, an alternating current (AC) inlet 13 for supplying device power, and external connection terminals 14 for connecting to external devices such as a personal computer and a video camera. A motion sensor 16 or the like is provided near the projection window 3 to serve as a safety device that stops the emission of projection light when a person approaches. This function can be disabled depending on the intended usage situation.

A left side plate 2c forms a left side surface of the housing 2 and has an exhaust port for exhausting air in the housing 2. On the other hand, the right side plate 2d of the housing 2 has an intake port 17 for taking in outside air. The air taken into the housing 2 through the intake port 17 flows through the housing 2 and cools the components in the housing 2, resulting in an increase in temperature. The air having increased in temperature is discharged to the outside through the exhaust port provided in the left side plate 2c. The position of the intake port 17 and the position of the exhaust port are an example, and an intake/exhaust port may be provided in, for example, a front side 2b of the housing 2 to efficiently cool the air.

The projector 1 can project an image onto a screen or the like using an illumination optical unit including a light source, a digital mirror device (DMD), and other components.

Next, the image projection system according to the present embodiment will be described.

The image projection system according to the present embodiment is used when, for example, the projector 1 described above is used in an application where a horizontal surface such as a floor surface or a ceiling surface serves as the projection surface. In a specific example, work for drawing dimension lines, called marking work, is performed at a construction site or the like. During the marking work, the image projection system can be used to project an image such as a design drawing onto the floor surface. A worker can trace the projected image (e.g., design drawing) to draw dimension lines on the floor surface, thereby streamlining and simplifying the work.

In the image projection system used for such marking work, it is desirable to adjust parameters of a projection image such as a design drawing, including the size, shape (e.g., correction of trapezoidal distortion), and rotation angle (e.g., the rotation angle about a rotation axis perpendicular to the image plane) of the projection image. Accordingly, the image projection system includes at least a mechanism (or a mover) for changing the height of the projector 1 (the distance between the projection apparatus and the floor surface serving as the projection surface) to change the size of a projection image, and a mechanism (a rotator) for rotating the projector 1 to change the shape or the rotation angle of the projection image.

However, in a configuration in which the height of the projector 1 greatly changes in conjunction with the rotation of the projector 1, it is difficult to adjust the size, shape, rotation angle, and the like of the projection image, and it is challenging to achieve a desired projection image. This issue is particularly observed in the marking work described above. For example, a dimension is marked at a distance defined from a reference position (e.g., a pillar of a building), and thus the projection image such as the design drawing is adjusted with the distance between the projection image and the reference position maintained constant. In the marking work, therefore, it is more challenging to achieve a desired projection image.

Accordingly, the image projection system according to the present embodiment supports the projector 1 described above by using a carriage 100 to facilitate adjustment of a projection image to be projected onto the floor surface, and adjusts the projection image by using various mechanisms provided in the carriage 100.

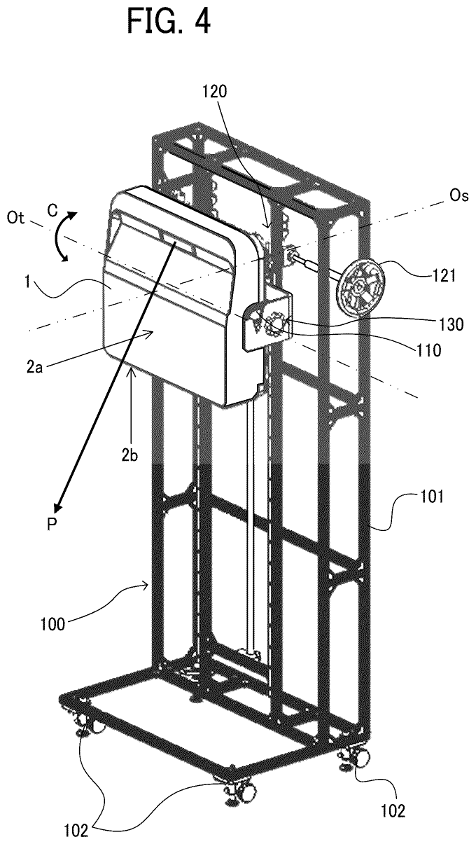

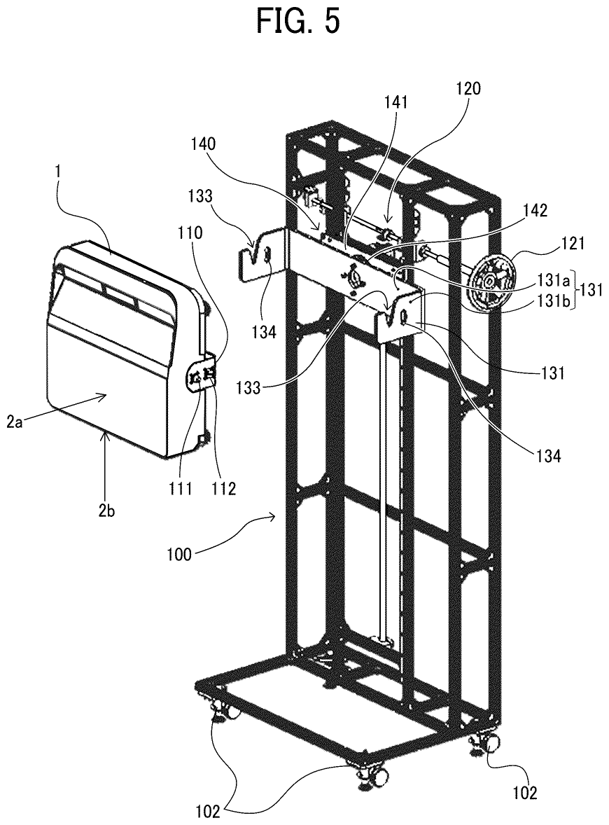

FIGS. 4 and 5 are perspective views of the image projection system according to the present embodiment.

In the image projection system illustrated in FIG. 4, the projector 1 described above is mounted on the carriage 100.

In the image projection system illustrated in FIG. 5, the projector 1 and a bracket 110 described below are separated from the carriage 100.

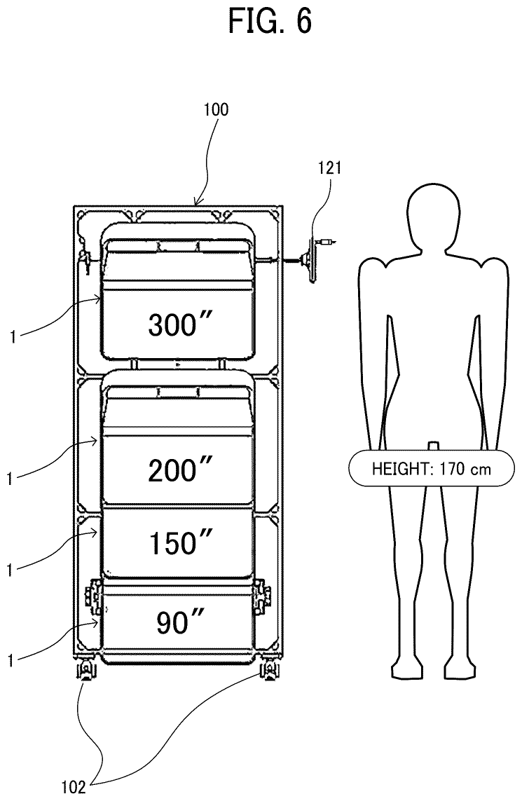

In the image projection system according to the present embodiment, by changing the height of the projector 1, the distance between the projector 1 and the floor surface serving as the projection surface can be changed, and the size of an image to be projected onto the floor surface can be increased or decreased. FIG. 6 illustrates an example correspondence relationship between heights of the projector 1 and sizes of an image to be projected onto the floor surface. In FIG. 6, the image projection system is displayed alongside an image of a person with a height of 170 cm to provide an indication of the height of the projector 1.

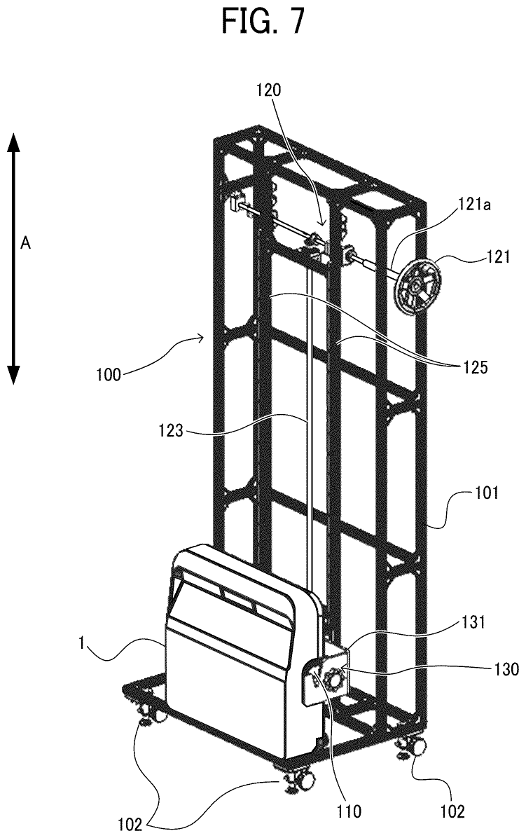

The projector 1 described above has a throw ratio TR of 0.22. The throw ratio is the ratio of the projection distance to the screen width (i.e., TR=projection distance/screen width). That is, the projector 1 described above is an image projection apparatus belonging to a category called an ultra-short throw projector with a throw ratio of about 0.2 to about 0.5. Accordingly, for example, when the throw ratio TR is 0.22, the height of the projector 1 is set to about 150 cm to project a projection image corresponding to a display size of 300 inches onto the floor surface. When a projection image corresponding to a display size of 300 inches is to be projected onto the floor surface, the height of the projector 1 relative to the carriage 100 is set as illustrated in FIG. 4. When a projection image corresponding to a display size of 90 inches is to be projected onto the floor surface, the height of the projector 1 relative to the carriage 100 is set as illustrated in FIG. 7.

To project a projection image corresponding to a display size of 300 inches, the height of the projector 1 is set to a value less than or equal to 150 cm when the projector 1 has a throw ratio TR of 0.18 to 0.22, which is suitable for a person to work in a standing position, considering the operability based on the average height of people. On the other hand, to project a projection image corresponding to a display size of 300 inches or more, the projector 1 is located at a position higher than the height of the person illustrated in FIG. 6 when the throw ratio TR exceeds 0.22, resulting in a decrease in operability. The carriage 100 according to the present embodiment can preferably be used for a projector having a throw ratio TR of about 0.2 to about 0.5, which depends on the display size. More preferably, the throw ratio TR is 0.2 to 0.3. A projector having a throw ratio TR outside the above range may also be used.

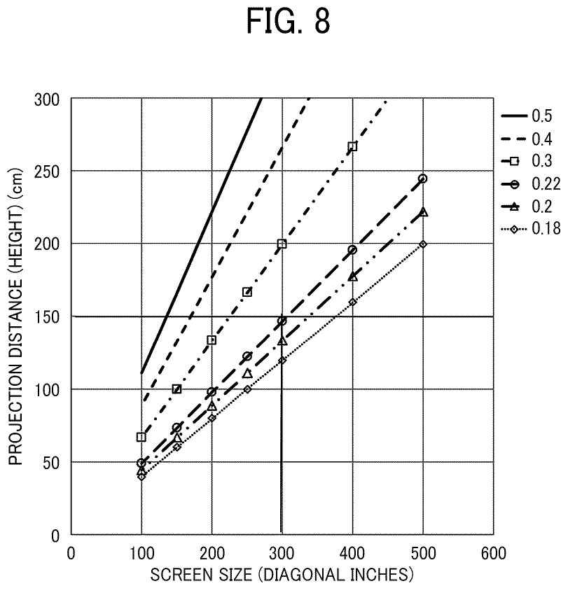

FIG. 8 is a graph plotting, for each of throw ratios TR (0.18, 0.2, 0.22, 0.3, 0.4, and 0.5) of the projector 1, the relationship between the screen size (in diagonal inches) and the projection distance (height) for projection onto the floor surface.

To increase the size (screen size) of the projection image to be projected onto the floor surface, the projector 1 is moved upward in the direction (vertical direction) perpendicular to the floor surface. When the projector 1 is used indoors, in consideration of the height of the ceiling, it is desirable to set the upper limit of the height of the projector 1 to about 250 cm. When the projector 1 has a throw ratio TR of 0.5, the screen size can be increased up to 200 inches (in the case of an aspect ratio of 10:9) within the upper limit of the height of the projector 1 described above.

However, to project a projection image corresponding to a larger screen size (e.g., 300 inches), the projector 1 is moved to a position higher than the upper limit of the height of the projector 1 described above. In this case, when the projector 1 is used indoors, the projector 1 may have to be set at a position higher than the ceiling, and therefore it is difficult to obtain a projection image corresponding to such a large screen size.

The projector 1 having a smaller throw ratio TR can project a projection image corresponding to a larger screen size without the upper limit of the height of the projector 1 described above being exceeded. For example, the projector 1 having a throw ratio TR of about 0.3 can project a projection image corresponding to a screen size of 300 inches even when the projection distance is 200 cm. In this case, it is possible to obtain a projection image corresponding to a large screen size of 300 inches or more even in indoor applications (in-room applications) where people are expected to reside (i.e., even when the height of the projector 1 is set to a value less than the height of the ceiling). When the projector 1 having a smaller throw ratio TR is used, the projection distance can further be shortened, and thus the height of the projector 1 can further be reduced.

When the projector 1 having a small throw ratio TR is used, however, a slight shift in the position of the projector 1 causes a large deviation in the position of the projected image from the desired position. Accordingly, it is difficult for the projector 1 having a small throw ratio TR (e.g., a projector having a throw ratio smaller than 0.2) to perform alignment for projecting a projection image at a target projection position. In addition to this issue, as the throw ratio TR decreases, the size of the projector 1 increases, and the ease of handling (or ease of use) of the projector 1 decreases.

When the screen size to be projected is small, no problem occurs even if the throw ratio TR of the projector 1 is small. To increase the screen size to, for example, 300 inches or more, it is desirable to set the lower limit of the throw ratio TR in consideration of the issues described above. From this point of view, the throw ratio TR of the projector 1 is preferably greater than or equal to 0.18.

Accordingly, the throw ratio TR of the projector 1 according to the present embodiment is preferably within a range of 0.18 or more to 0.5 or less in order to obtain a projection image having a large screen size. More preferably, the throw ratio TR is within a range of 0.2 or more to 0.3 or less in consideration of the height of the ceiling in indoor applications and the ease of handling (or operability) of the projector 1 by the user. As long as the throw ratio TR is within the range described above, particularly when the vertical direction (the direction of gravity) is set as the projection direction to perform a projection, such as when a projection is cast onto the floor surface, the projector 1 can be appropriately used even in a limited space in a room, or the position of the projector 1 is not too high for the user to handle the projector 1 easily.

The carriage 100 according to the present embodiment includes a main body frame 101, casters 102, a bracket 110 serving as a base unit (or a base), an elevating mechanism 120 serving as a mover, a tilt adjustment mechanism 130 serving as a rotator, and a swivel mechanism 140 serving as a second rotator.

In the carriage 100 according to the present embodiment, the casters 102 are provided at the four corners of the bottom of the main body frame 101. This configuration allows the carriage 100 to be smoothly moved to a target location on the floor surface. Preferably, the carriage 100 is provided with a fixing unit to fix the carriage 100 to the floor surface, and the casters 102 prevent easy movement of the carriage 100 in a target installation location. One example of the fixing unit may be a lock mechanism provided in each of the casters 102.

The casters 102 may be replaced with another support. Examples of such a support include legs that support the carriage 100 and the projector 1 mounted on the carriage 100 by contacting the floor surface, which is a placement surface on which the carriage 100 is placed, at three or more contact points. In this case, for example, three or more legs may be brought into direct contact with the floor surface, and static friction between the floor surface and the legs, resulting from the weight of the carriage 100, may secure the carriage 100 in place. The support may be configured to support the carriage 100 by contacting the floor surface at three, four, or more contact points, thereby supporting the carriage 100 more stably. A simplified configuration may involve supporting the carriage 100 by contacting the floor surface at three points (e.g., a support including three casters or three legs).

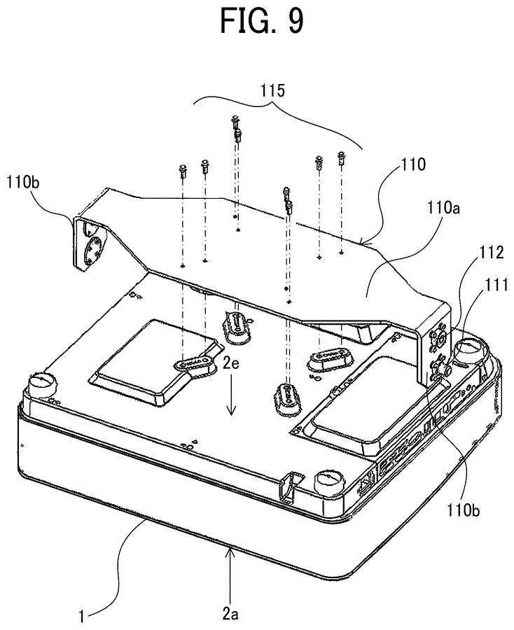

FIG. 9 is a perspective view of the bracket 110 serving as a base on which the projector 1 is mountable.

The bracket 110 includes a main plate portion 110a and two side portions 110b. The main plate portion 110a is located at a position facing a bottom plate 2e, which forms a bottom surface of the projector 1. The side portions 110b are located at positions facing the left side plates 2c and the right side plate 2d of the projector 1. The bracket 110 can be produced by, for example, bending both ends of a single elongated plate-shaped member in the elongated direction at an angle of 90 degrees. The main plate portion 110a has through holes through which fixing screws 115 to be fastened into screw holes provided in the bottom plate 2e of the projector 1 pass. By fastening the fixing screws 115 into the screw holes in the bottom plate 2e of the projector 1 via the through holes in the main plate portion 110a, the projector 1 is mounted on the bracket 110.

Each of the side portions 110b of the bracket 110 has an engagement pin 111 and a fixing screw hole 112. The engagement pin 111 is provided so as to protrude outward from an outer surface of each of the side portions 110b. The engagement pin 111 is mounted in a recess formed in a mount 131 of the tilt adjustment mechanism 130 described below. A flanged bolt 132 of the tilt adjustment mechanism 130 described below is fastened into the fixing screw hole 112. By fastening the flanged bolt 132 into the fixing screw hole 112, the bracket 110 is fixed to the mount 131 of the tilt adjustment mechanism 130.

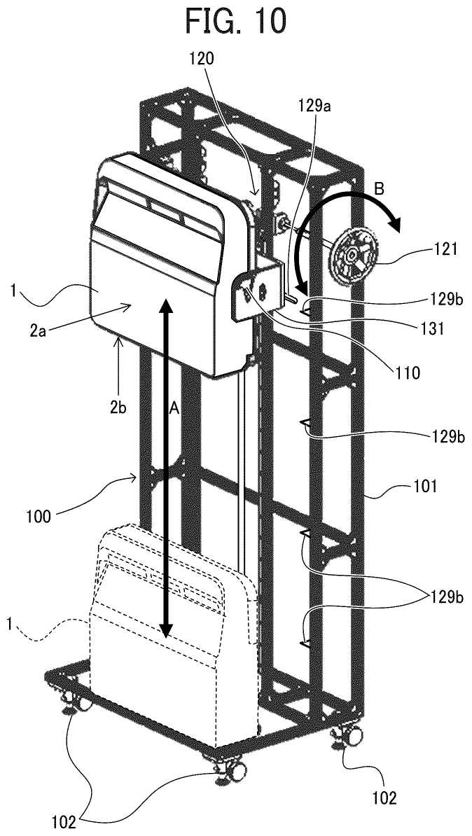

FIG. 10 is an explanatory diagram illustrating the movement of the elevating mechanism 120 according to the present embodiment.

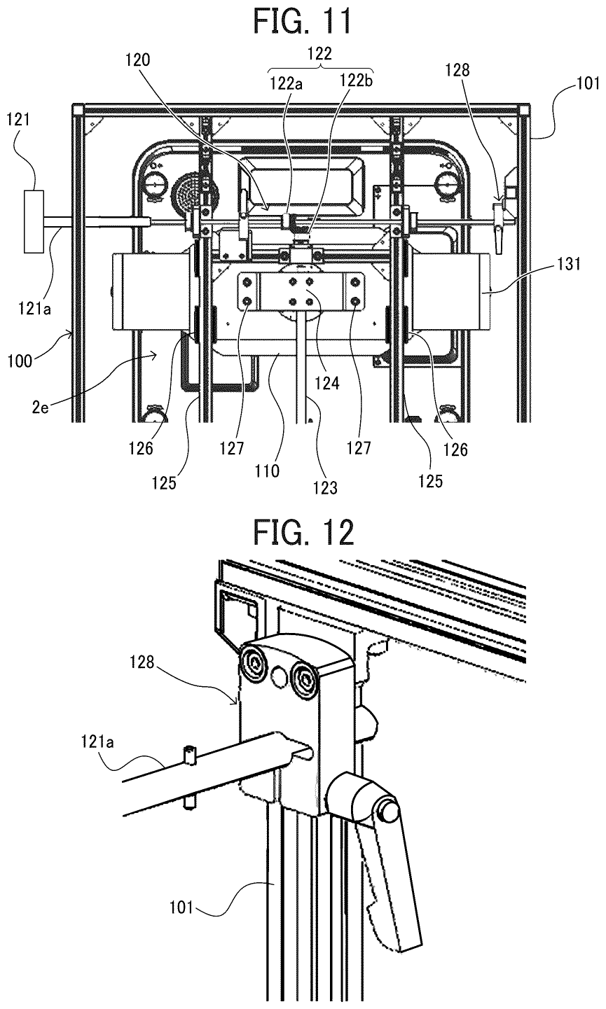

FIG. 11 is an explanatory diagram illustrating the configuration of a main portion of the elevating mechanism 120.

FIG. 12 is an explanatory diagram illustrating a shaft clamp of the elevating mechanism 120.

The elevating mechanism 120 according to the present embodiment includes an operation handle 121, a joint portion 122, an elevating screw 123, a nut bracket 124, guide rails 125, guide portions 126, fixing portions 127, and a shaft clamp 128.

In the elevating mechanism 120 according to the present embodiment, when the operation handle 121, which is supported so as to be rotatable with respect to the main body frame 101, is turned as indicated by an arrow B in FIG. 10, a shaft 121a of the operation handle 121 axially rotates. The joint portion 122 couples the shaft 121a of the operation handle 121 extending in the horizontal direction to the elevating screw 123 extending in the vertical direction (i.e., the direction of gravity). The joint portion 122 is constructed by meshing a first bevel gear 122a and a second bevel gear 122b with each other. The first bevel gear 122a is provided on the shaft 121a of the operation handle 121. The second bevel gear 122b is provided on the elevating screw 123. When the first bevel gear 122a rotates in response to the rotation of the operation handle 121, the rotational force of the first bevel gear 122a is transmitted to the second bevel gear 122b, and the elevating screw 123 axially rotates.

The nut bracket 124 is engaged with the elevating screw 123. The main body frame 101 is provided with two guide rails 125 extending in the vertical direction, and the guide portions 126 are mounted so as to be slidable in the vertical direction along the two guide rails 125. The nut bracket 124 is fixed to a swivel base 141 of the swivel mechanism 140 described below by the fixing portions 127, and the guide portions 126 are also fixed to the swivel base 141. With this configuration, when the elevating screw 123 axially rotates, the nut bracket 124, which is fixed through the guide portions 126 guided along the two guide rails 125 and the swivel base 141, rotates relative to the elevating screw 123. As a result, the nut bracket 124 and the guide portions 126 move in the axial direction of the elevating screw 123 (i.e., the vertical direction) while being guided along the two guide rails 125.

The projector 1 is mounted on the bracket 110, and the bracket 110 is mounted on the tilt adjustment mechanism 130 described below. The tilt adjustment mechanism 130 is supported by the swivel base 141 of the swivel mechanism 140. Accordingly, when the operation handle 121 of the elevating mechanism 120 is turned, the nut bracket 124 moves in the vertical direction. Along with the movement of the nut bracket 124, the bracket 110 moves in the vertical direction together with the tilt adjustment mechanism 130 supported by the swivel base 141.

As a result, the height of the projector 1 mounted on the bracket 110 can be changed. The elevating mechanism 120 according to the present embodiment functions as a mover to move the position (or a position in a direction of gravity, which is referred to simply as a gravity-directed position) of the bracket 110, on which the projector 1 is mounted, in a predetermined movement direction (e.g., the vertical direction or the direction of gravity).

The shaft clamp 128 is provided on the shaft 121a of the operation handle 121. By operating and tightening the shaft clamp 128, the axial rotation of the shaft 121a of the operation handle 121 can be locked. After the height of the projector 1 is set by turning the operation handle 121, the shaft clamp 128 is operated and tightened, thereby fixing the height of the projector 1.

In the present embodiment, by changing the height of the projector 1 using the elevating mechanism 120, the distance between the projector 1 and the floor surface serving as the projection surface is changed. Thus, the size of a projection image to be projected onto the floor surface can be changed. As illustrated in FIG. 10, the main body frame 101 may be provided with a plurality of target indicators 129b to facilitate the operation of adjusting the size of the projection image to be projected onto the floor surface by changing the height of the projector 1 using the elevating mechanism 120. The target indicators 129b are configured to notify the user of, for example, corresponding image sizes (i.e., the sizes of projection images to be projected onto the floor surface). This configuration allows the user to easily adjust the size of a projection image to be projected onto the floor surface to a desired image size by adjusting the height of the projector 1. Specifically, the user adjusts the height of the projector 1 such that a reference position indicator 129a provided on the mount 131 supporting the bracket 110 on which the projector 1 is mounted is aligned with any one of the target indicators 129b on the main body frame 101.

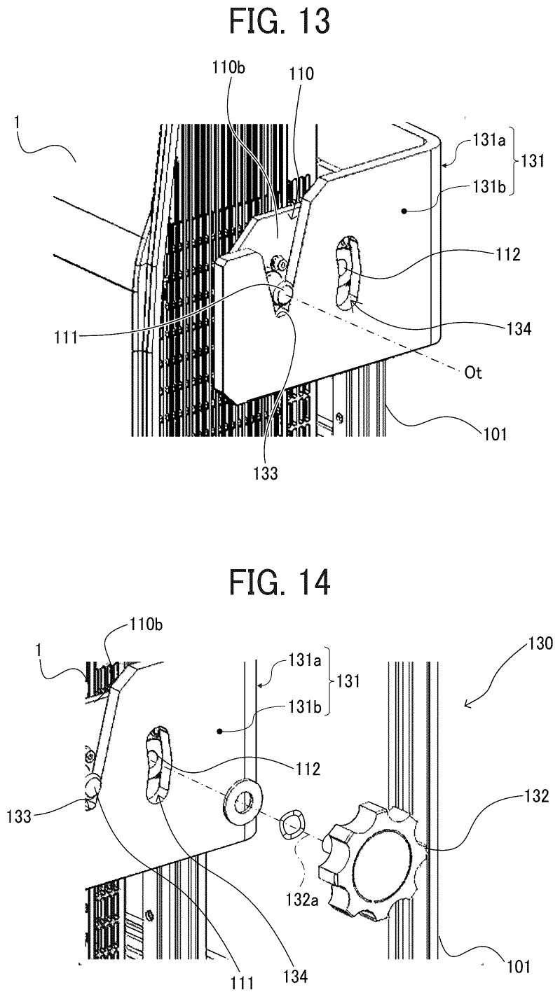

FIG. 13 is an explanatory diagram illustrating the movement of the tilt adjustment mechanism 130 according to the present embodiment.

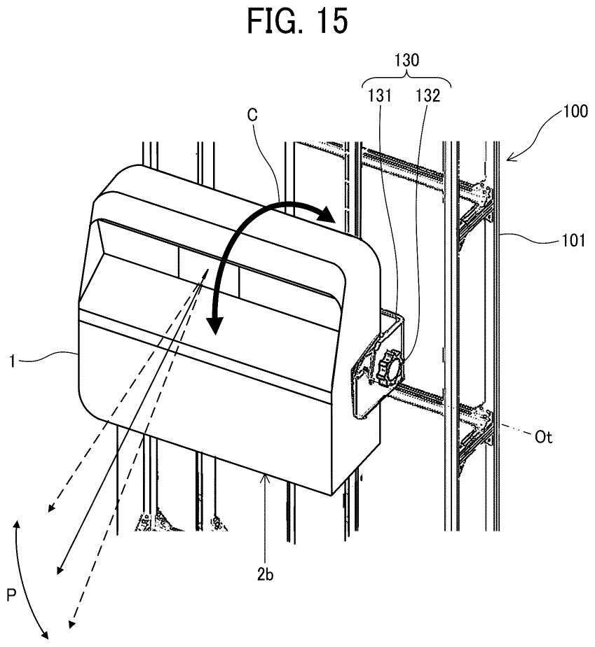

FIG. 14 is an explanatory diagram illustrating the configuration of a fixing portion of the tilt adjustment mechanism 130.

The tilt adjustment mechanism 130 according to the present embodiment includes the mount 131 and the flanged bolt 132 serving as a fixing portion.

The mount 131 includes a mount base 131a disposed at a position facing the main plate portion 110a of the bracket 110 on which the projector 1 is mounted. That is, the mount base 131a is disposed at a position facing the bottom plate 2e of the projector 1. The mount 131 further includes two mount side portions 131b disposed at positions facing the two side portions 110b of the bracket 110. That is, the mount side portions 131b are disposed at positions facing the left side plate 2c and the right side plate 2d of the projector 1. The mount 131 can be produced by, for example, bending both ends of a single elongated plate-shaped member in the elongated direction at an angle of 90 degrees.

Each of the mount side portions 131b of the mount 131 is formed with a recess 133 to receive the engagement pin 111 provided on the corresponding one of the side portions 110b of the bracket 110. The recess 133 has a shape that is open toward the top, and supports the engagement pin 111 from below. The engagement pins 111 of the bracket 110 are supported from below by the recesses 133 of the mount 131. Thus, the bracket 110 is held so as to be rotatable relative to the mount 131 about a tilt rotation axis Ot extending through the axes of the engagement pins 111.

Each of the mount side portions 131b of the mount 131 is also formed with an arcuate through groove 134 through which a bolt shaft 132a of the flanged bolt 132 passes. The flanged bolt 132 is fastened into the fixing screw hole 112 provided in the corresponding one of the side portions 110b of the bracket 110. The arcuate through groove 134 is an arc-shaped groove extending along a path followed by the fixing screw hole 112 of the bracket 110 when the bracket 110 rotates about the tilt rotation axis Ot. Thus, in a state where the bolt shaft 132a is inserted into the arcuate through groove 134 of the mount 131 and the flanged bolt 132 is placed in the fixing screw hole 112 of the bracket 110 (i.e., in a state where the flanged bolt 132 is loose), the movement of the bolt shaft 132a is restricted at both ends of the arcuate through groove 134 to limit the range of rotation of the bracket 110 about the tilt rotation axis Ot. Thus, the range of rotation of the bracket 110 about the tilt rotation axis Ot can be limited to, for example, a range in which the projector 1 mounted on the bracket 110 does not come into contact with the main body frame 101.

With the tilt adjustment mechanism 130 according to the present embodiment, as illustrated in FIG. 15, by rotating the bracket 110 about the tilt rotation axis Ot as indicated by an arrow C with the flanged bolt 132 loose, a projection direction P of the projector 1 mounted on the bracket 110 can be changed about the tilt rotation axis Ot. After the projection direction P of the projector 1 about the tilt rotation axis Ot is set to a desired direction, the flanged bolt 132 is tightened.

As a result, the bracket 110 is fixed to the mount 131 of the tilt adjustment mechanism 130, and the projection direction P of the projector 1 about the tilt rotation axis Ot is fixed.

The projection surface is a floor surface, and the projection direction P is inclined from the vertical direction to project the image onto the floor surface at an angle. This angle can be adjusted around the tilt rotation axis Ot and may, for example, be set to an acute angle.

As illustrated in FIG. 15, the tilt adjustment mechanism 130 according to the present embodiment is positioned such that the tilt rotation axis Ot, which is a rotation axis of the tilt adjustment mechanism 130, passes through the region of the projector 1 mounted on the bracket 110. If the tilt rotation axis Ot of the tilt adjustment mechanism 130 is positioned outside the region of the projector 1, the projector 1 is offset from the tilt rotation axis Ot. Thus, when the tilt adjustment mechanism 130 rotates, the projector 1 moves along a large circular path about the tilt rotation axis Ot. Thus, when the projection direction P of the projector 1 is changed about the tilt rotation axis Ot by the rotation of the tilt adjustment mechanism 130 to adjust a projection image to be projected onto the floor surface (e.g., adjust the shape of the projection image), the position of the projector 1 also changes greatly. Such a great change in the position of the projector 1 alters the position, size, shape, or the like of the projection image. As a result, it becomes difficult to perform adjustment for obtaining a desired projection image.

In contrast, as in the tilt adjustment mechanism 130 according to the present embodiment, when the tilt rotation axis Ot is positioned so as to pass through the region of the projector 1 mounted on the bracket 110, the position of the projector 1 is closer to the tilt rotation axis Ot than that in the configuration described above. As a result, when the projection direction P of the projector 1 is changed about the tilt rotation axis Ot by the rotation of the tilt adjustment mechanism 130 to adjust a projection image to be projected onto the floor surface (e.g., adjust the shape of the projection image), the change in the position of the projector 1 is reduced. Thus, when the projection direction P of the projector 1 is changed about the tilt rotation axis Ot to adjust the projection image on the floor surface, the change in the position, size, shape, or the like of the projection image is reduced. It is easy to perform adjustment for obtaining a desired projection image.

In particular, in the tilt adjustment mechanism 130 according to the present embodiment, the tilt rotation axis Ot is positioned so as to pass through a region where the projection optical system 15 of the projector 1 mounted on the bracket 110 is located. Accordingly, when the projection direction P of the projector 1 is changed about the tilt rotation axis Ot to adjust a projection image to be projected onto the floor surface, the change in the position, size, shape, or the like of the projection image is further reduced. It is easier to perform adjustment for obtaining a desired projection image.

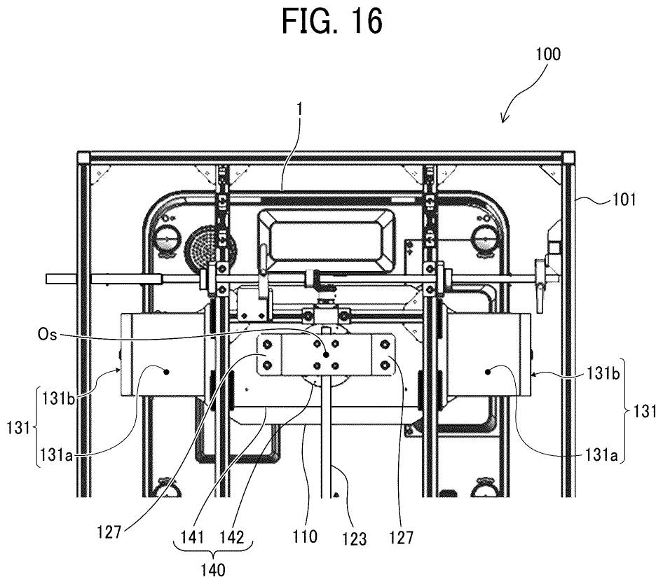

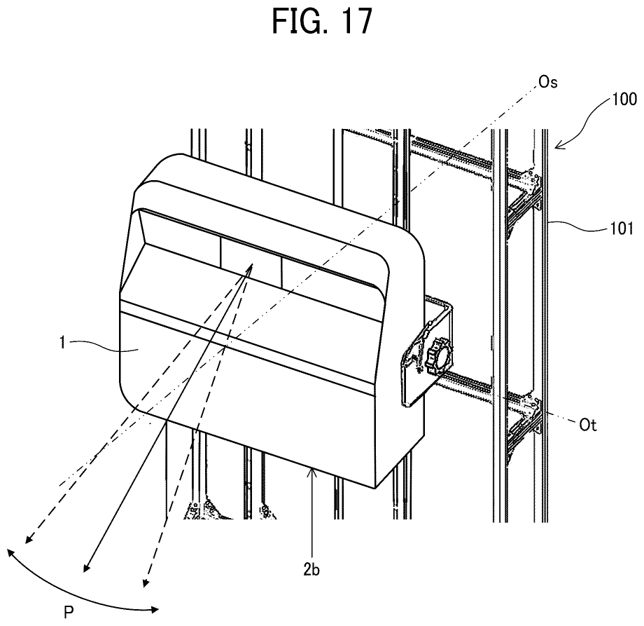

FIG. 16 is an explanatory diagram illustrating the swivel mechanism 140 according to the present embodiment.

FIG. 17 is an explanatory diagram illustrating the movement of the swivel mechanism 140.

The swivel mechanism 140 according to the present embodiment includes the swivel base 141 and a swivel joint portion 142.

The swivel base 141 is disposed at a position facing the mount base 131a of the mount 131 in the tilt adjustment mechanism 130. That is, the swivel base 141 is disposed at a position facing the bottom plate 2e of the projector 1. The swivel base 141 is fixed to the nut bracket 124 of the elevating mechanism 120 by the fixing portions 127. Thus, when the nut bracket 124 is raised and lowered by the elevating mechanism 120, the swivel mechanism 140 and the tilt adjustment mechanism 130 are also raised and lowered, and the projector 1 mounted on the bracket 110 is raised and lowered.

The swivel joint portion 142 couples the swivel base 141 to the mount 131 of the tilt adjustment mechanism 130. The swivel joint portion 142 couples the swivel base 141 to the mount 131 of the tilt adjustment mechanism 130 such that the mount 131 is rotatable relative to the swivel base 141 about a swivel rotation axis Os. The swivel joint portion 142 has a free stop structure. When a force exceeding a locking force for rotation about the swivel rotation axis Os is applied to the mount 131, the mount 131 can rotate about the swivel rotation axis Os. When the rotation is stopped, the mount 131 is secured in position and fixed to the swivel base 141.

With the swivel mechanism 140 according to the present embodiment, as illustrated in FIG. 17, when the projector 1 mounted on the bracket 110, the mount 131, and the like are held and rotated about the swivel rotation axis Os, the projection direction P of the projector 1 mounted on the bracket 110 can be changed about the swivel rotation axis Os.

As illustrated in FIG. 17, the swivel rotation axis Os, which is the rotation axis of the swivel mechanism 140 according to the present embodiment, is positioned so as to pass through the region of the projector 1 mounted on the bracket 110. If the swivel rotation axis Os of the swivel mechanism 140 is positioned outside the region of the projector 1, the projector 1 is offset from the swivel rotation axis Os. Thus, when the swivel mechanism 140 rotates, the projector 1 moves along a large circular path about the swivel rotation axis Os. Thus, when the projection direction P of the projector 1 is changed about the swivel rotation axis Os by the rotation of the swivel mechanism 140 to adjust a projection image to be projected onto the floor surface (e.g., adjust the shape of the projection image), the position of the projector 1 also changes greatly. Such a great change in the position of the projector 1 alters the position, size, shape, or the like of the projection image. As a result, it becomes difficult to perform adjustment for obtaining a desired projection image.

In contrast, as in the swivel mechanism 140 according to the present embodiment, when the swivel rotation axis Os is positioned so as to pass through the region of the projector 1 mounted on the bracket 110, the position of the projector 1 is closer to the swivel rotation axis Os than that in the configuration described above. As a result, when the projection direction P of the projector 1 is changed about the swivel rotation axis Os by the rotation of the swivel mechanism 140 to adjust a projection image to be projected onto the floor surface (e.g., adjust the shape of the projection image), the change in the position of the projector 1 is reduced. Thus, when the projection direction P of the projector 1 is changed about the swivel rotation axis Os to adjust the projection image on the floor surface, the change in the position, size, shape, or the like of the projection image is reduced. It is easy to perform adjustment for obtaining a desired projection image.

In particular, in the swivel mechanism 140 according to the present embodiment, the swivel rotation axis Os is positioned so as to pass through a region where the projection optical system 15 of the projector 1 mounted on the bracket 110 is located. Accordingly, when the projection direction P of the projector 1 is changed about the swivel rotation axis Os to adjust the projection image, the change in the position, size, shape, or the like of the projection image is further reduced. It is easier to perform adjustment for obtaining a desired projection image.

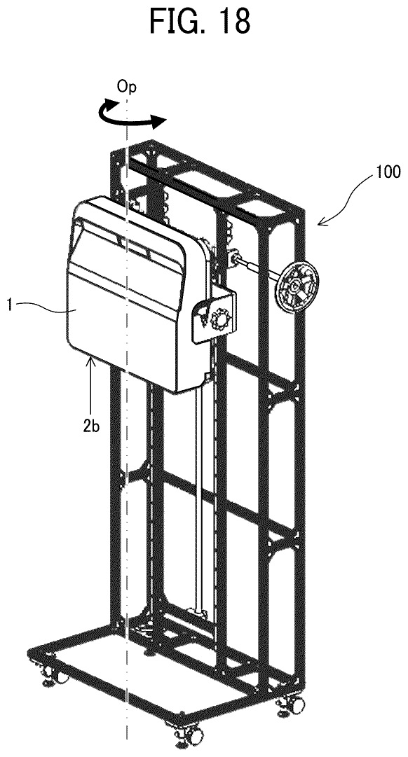

In the present embodiment, to adjust the rotation angle of a projection image to be projected onto the floor surface (i.e., the rotation angle about the rotation axis perpendicular to the image plane), in one example, as illustrated in FIG. 18, the casters 102 of the carriage 100 may be rolled to rotate the main body frame 101 of the carriage 100 about a rotation axis Op. In another example, a rotator may be provided on the carriage 100 to rotate the main body frame 101 about the rotation axis Op, and the rotation angle of the projection image may be adjusted by the rotation of the rotator.

Positioning the rotation axis Op so as to pass through the region of the projector 1 mounted on the bracket 110 facilitates adjustment to obtain a desired projection image. In particular, positioning the rotation axis Op so as to pass through a region where the projection optical system 15 of the projector 1 mounted on the bracket 110 is located further facilitates adjustment to obtain a desired projection image.

In the carriage 100 according to the present embodiment, the support including the four casters 102 at the four corners of the bottom of the main body frame 101 contacts the floor surface, which is the placement surface, and supports the carriage 100 and the projector 1 mounted on the carriage 100. Preferably, the center of gravity of the projector 1 mounted on the bracket 110 is vertically above a region on the floor surface defined by the four contact points at which the four casters 102 contact the floor surface. In other words, when viewed in the vertical direction, the center of gravity of the projector 1 is within a rectangle defined by the points at which the four casters 102 supporting the projector 1 at four points contact the floor surface.

The number of contact points at which the support contacts the floor surface is not limited to four. For example, the support may include a tripod having three contact points. By configuring the support to make contact with the floor surface at four or more contact points, the load is more evenly distributed, providing more stable support. A stable support with even distribution of the load does not fall over easily even when the projector 1 is mounted at a high position to increase the projection distance.

When the support includes a tripod, for example, the support is provided with a vertically movable mast at a coupling portion at the base of the tripod, and all or some of an elevating mechanism, a tilt adjustment mechanism, and a swivel mechanism, including the bracket 110 serving as a base, the elevating mechanism 120 serving as a mover, the tilt adjustment mechanism 130 serving as a rotator, and the swivel mechanism 140 serving as a second rotator, may be provided in an upper portion of the mast. The tripod is easy to fold and achieves improved portability.

More preferably, the center of gravity of the projector 1 is on a vertical line passing through or near the center of gravity of the region on the floor surface defined by the four contact points at which the four casters 102 contact the floor surface. It is desirable for the center of gravity of the projector 1 to move along the vertical line when the height of the projector 1 is adjusted (to adjust the projection distance).

With this configuration, a more stable support that does not fall over easily is achieved.

As in the present embodiment, the configuration that can move the projector 1 in the vertical direction allows the projector 1 to move along a mast extending in the height direction of the main body frame 101 of the carriage 100. The mast extending in the height direction of the main body frame 101 is less likely to impair the handling of the carriage 100, even if the mast is made longer than a mast extending in the horizontal direction. Thus, the configuration that can move the projector 1 in the vertical direction makes it easy to increase the movement distance (movement range) of the projector 1. As a result, the adjustment range of the projection distance with respect to the projection surface, which is the floor surface, can be increased, resulting in an increase in the adjustment range of the screen size.

In another example, the tilt adjustment mechanism 130 serving as a rotator and the swivel mechanism 140 serving as a second rotator may be provided in a location separate from the bracket 110 serving as a base.

The range in which the elevating mechanism 120 can raise and lower the projector 1 is preferably greater than or equal to the size of the projector 1, but may be less than or equal to the size of the projector 1. The elevating mechanism 120 may be a mechanism that enables fine adjustments that convert the feed of a microhead into the vertical direction, or may be driven by an electric motor.

In another example, the carriage 100 is not installed on the same floor surface as the projection surface, but may be installed on a placement surface different from the projection surface, such as the top of a desk or a stage.

The configurations described above are examples, and aspects of the present disclosure provide respective effects as follows.

In a first aspect, a projection image adjustment apparatus (e.g., the carriage 100) includes a base (e.g., the bracket 110) on which a projection apparatus (e.g., the projector 1) is mountable, a mover (e.g., the elevating mechanism 120), and a rotator (e.g., the tilt adjustment mechanism 130). The mover moves a position of the base in a predetermined movement direction (e.g., the vertical direction). The rotator rotates the projection apparatus about a rotation axis (e.g., the tilt rotation axis Ot) perpendicular to a plane including the predetermined movement direction and a projection direction (e.g., the projection direction P) of the projection apparatus. The rotation axis is positioned so as to pass through a region of the projection apparatus mounted on the base.

A projection image adjustment apparatus includes a base attached to a projection apparatus to project a light in a projection direction; a mover to move the base in a movement direction; and a rotator including a mount to mount the base attached to the projection apparatus; and an imaginary rotation axis perpendicular to a plane including the movement direction and the projection direction. The mount is rotatable about the imaginary rotation axis. The imaginary rotation axis passes through a region of the projection apparatus mounted on the mount via the base.

In a projection image adjustment apparatus of the related art, a rotation axis about which a projection apparatus is rotated to change the orientation of the projection direction of the projection apparatus is located at a position greatly away from the region of the projection apparatus. Thus, when the projection apparatus is rotated, the position of the projection apparatus greatly changes in conjunction with the rotation of the projection apparatus.

As a result, in the adjustment of the position, size, shape, and rotation angle (e.g., the rotation angle about a rotation axis perpendicular to the image plane) of a projection image to be projected onto a projection surface, for example, even when the projection image is to be adjusted by changing only the projection direction of the projection apparatus, the position of the projection apparatus also changes, making it difficult to adjust the projection image to a desired projection image.

According to this aspect, the projection image can be adjusted by moving the position of the base in a predetermined movement direction using the mover and rotating the projection apparatus about a rotation axis perpendicular to a plane including the predetermined movement direction and the projection direction of the projection apparatus using the rotator. In this aspect, the rotation axis of the rotator is positioned so as to pass through the region of the projection apparatus mounted on the base. This configuration can reduce the amount of change in the position of the projection apparatus with respect to the amount of change in the rotation angle of the rotator, compared to the projection image adjustment apparatus of the related art. According to this aspect, therefore, when the projection apparatus is rotated by the rotator to change the orientation of the projection direction, the change in the position of the projection apparatus in conjunction with the rotation of the projection apparatus can be reduced, facilitating the adjustment of the projection image.

According to a second aspect, in the projection image adjustment apparatus of the first aspect, the rotation axis is positioned so as to pass through a region in which a projection optical system (e.g., the projection optical system 15) of the projection apparatus is located.

The imaginary rotation axis passes through a region in a projection optical system in the projection apparatus.

According to this aspect, when the projection apparatus is rotated by the rotator to change the orientation of the projection direction, the change in the position of the projection apparatus in conjunction with the rotation of the projection apparatus can further be reduced, further facilitating the adjustment of the projection image.

According to a third aspect, the projection image adjustment apparatus of the first aspect or the second aspect further includes a second rotator (e.g., the swivel mechanism 140) to rotate the projection apparatus about a second rotation axis (e.g., the swivel rotation axis Os) perpendicular to a second plane including the predetermined movement direction and a direction perpendicular to the plane.

The projection image adjustment apparatus further includes another rotator having another imaginary rotation axis perpendicular to another plane including the imaginary rotation axis and orthogonal to the plane. The mount is rotatable about said another imaginary rotation axis.

This configuration allows the orientation of the projection direction of the projection apparatus to be adjusted to that in a two-dimensional direction by a combination of the rotation of the rotator and the rotation of the second rotator described above, increases flexibility in adjusting the projection image.

According to a fourth aspect, in the projection image adjustment apparatus of the third aspect, the second rotation axis is positioned so as to pass through the region of the projection apparatus mounted on the base.

The another imaginary rotation axis passes through the region of the projection apparatus mounted on the mount via the base.

According to this aspect, when the projection apparatus is rotated by the second rotator to change the orientation of the projection direction, the change in the position of the projection apparatus in conjunction with the rotation of the projection apparatus can also be reduced, facilitating the adjustment of the projection image.

According to a fifth aspect, in the projection image adjustment apparatus of the fourth aspect, the second rotation axis is positioned so as to pass through a region in which a projection optical system of the projection apparatus is located.

The another imaginary rotation axis passes through a region in a projection optical system in the projection apparatus.

According to this aspect, when the projection apparatus is rotated by the second rotator to change the orientation of the projection direction, the change in the position of the projection apparatus in conjunction with the rotation of the projection apparatus can further be reduced, further facilitating the adjustment of the projection image.

According to a sixth aspect, in the projection image adjustment apparatus of any one of the first to fifth aspects, the mover moves the position of the base in a movement direction (e.g., the vertical direction) in which a distance between the projection apparatus mounted on the base and a projection surface (e.g., the floor surface) onto which projection light is projected from the projection apparatus is changed.

The mover moves the mount mounting the base in the movement direction to change a distance between the projection apparatus and a projection surface onto which projection light is projected from the projection apparatus.

With this configuration, the size of the projection image to be projected onto the projection surface can be changed by the movement of the mover, and the projection image can be adjusted.

According to a seventh aspect, in the projection image adjustment apparatus of the sixth aspect, the mover moves a gravity-directed position of the base along a direction of gravity.

The mover moves the mount in the movement direction along a direction of gravity to move the base attached to the projection apparatus.

With this configuration, when a projection image is projected onto a horizontal surface such as the floor surface or the ceiling surface as the projection surface, the size of the projection image can be adjusted by the movement of the mover.

According to an eighth aspect, in the projection image adjustment apparatus of the seventh aspect, the mover moves the gravity-directed position of the base in a direction opposite to gravity to increase the distance.

The mover moves the mount in a direction opposite to the direction of gravity to increase the distance.

With this configuration, when a projection image is projected onto the floor surface as the projection surface, the size of the projection image can be adjusted by the movement of the mover.

According to a ninth aspect, the projection image adjustment apparatus of the eighth aspect further includes a support (e.g., the four casters 102) to support the projection image adjustment apparatus while contacting, at three or more contact points, a placement surface on which the projection image adjustment apparatus is placed. The projection apparatus mounted on the base has a center of gravity vertically above a region on the placement surface, the region being defined by the three or more contact points.

The projection image adjustment apparatus further includes a support to contact a placement surface, on which the projection image adjustment apparatus is placed, at three or more contact points to support the projection image adjustment apparatus. The projection apparatus mounted on the base has a center of gravity above a region on the placement surface in the direction of gravity, the region being defined by the three or more contact points.

With this configuration, a projection image adjustment apparatus that is stable and does not fall over easily can be achieved even when the projection apparatus is moved to a high position away from the placement surface.

In a tenth aspect, an image projection system includes a projection apparatus (e.g., the projector 1) and a projection image adjustment apparatus (e.g., the carriage 100) to adjust a projection image to be projected onto a projection surface from the projection apparatus.

The projection image adjustment apparatus includes the projection image adjustment apparatus of the eighth aspect or the ninth aspect, and the projection apparatus has a throw ratio greater than or equal to 0.18 and less than or equal to 0.5.

An image projection system includes a projection apparatus to project a projection image onto a projection surface; and the projection image adjustment apparatus according to Aspect 8 to adjust a posture and a position of the projection apparatus to adjust the projection image on the projection surface. The projection apparatus has a throw ratio greater than or equal to 0.18 and less than or equal to 0.5.

With this configuration, when a projection image is projected onto the floor surface serving as the projection surface, a projection image having a large screen size exceeding, for example, 300 inches can be projected even within a range of a predetermined height upper limit (e.g., a height at which the image projection system can be used even indoors with a ceiling, or a height at which the user's handling (i.e., operability) of the image projection system can be ensured).

According to an eleventh aspect, in the image projection system of the tenth aspect, the projection apparatus has a throw ratio greater than or equal to 0.2 and less than or equal to 0.3.

The projection apparatus has a throw ratio greater than or equal to 0.2 and less than or equal to 0.3.

With this configuration, when a projection image is projected onto the floor surface serving as the projection surface, a projection image having a large screen size exceeding, for example, 300 inches can be easily obtained even within a range of a predetermined upper limit height.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A projection image adjustment apparatus comprising:
a base attached to a projection apparatus to project a light in a projection direction;
a mover to move the base in a movement direction; and
a rotator including:
a mount to mount the base attached to the projection apparatus; and
an imaginary rotation axis perpendicular to a plane including the movement direction and the projection direction,
wherein the mount is rotatable about the imaginary rotation axis, and
the imaginary rotation axis passes through a region of the projection apparatus mounted on the mount via the base.

2. The projection image adjustment apparatus according to claim 1,
wherein the imaginary rotation axis passes through a region in a projection optical system in the projection apparatus.

3. The projection image adjustment apparatus according to claim 1, further comprising another rotator having another imaginary rotation axis perpendicular to another plane including the imaginary rotation axis and orthogonal to the plane,
wherein the mount is rotatable about said another imaginary rotation axis.

4. The projection image adjustment apparatus according to claim 3,
wherein the another imaginary rotation axis passes through the region of the projection apparatus mounted on the mount via the base.

5. The projection image adjustment apparatus according to claim 4,
wherein the another imaginary rotation axis passes through a region in a projection optical system in the projection apparatus.

6. The projection image adjustment apparatus according to claim 1,
wherein the mover moves the mount in the movement direction to:
change a distance between the projection apparatus and a projection surface onto which projection light is projected from the projection apparatus.

7. The projection image adjustment apparatus according to claim 6,
wherein the mover moves the mount in the movement direction along a direction of gravity to move the base attached to the projection apparatus.

8. The projection image adjustment apparatus according to claim 7, wherein the mover moves the mount in a direction opposite to the direction of gravity to increase the distance.

9. The projection image adjustment apparatus according to claim 8, further comprising a support to contact a placement surface, on which the projection image adjustment apparatus is placed, at three or more contact points to support the projection image adjustment apparatus, wherein
the projection apparatus mounted on the base has a center of gravity above a region on the placement surface in the direction of gravity, the region being defined by the three or more contact points.

10. An image projection apparatus comprising:
a projector to emit light in a projection direction to project a projection image onto a projection surface,
wherein the projector has a throw ratio greater than or equal to 0.18 and less than or equal to 0.5.

11. The image projection apparatus according to claim 10,
wherein the projector has the throw ratio greater than or equal to 0.2 and less than or equal to 0.3.

12. The image projection apparatus according to claim 10,
wherein the projection surface is a floor surface, and
the projection direction is inclined relative to a vertical direction, to project the projection image onto the floor surface.

13. An image projection system comprising:
an image projection apparatus to emit light in a projection direction to project a projection image onto a projection surface; and
a projection image adjustment apparatus to adjust the projection image on the projection surface from the image projection apparatus,
wherein the image projection apparatus has a throw ratio greater than or equal to 0.18 and less than or equal to 0.5.

14. The image projection system according to claim 13, further comprising:
a base attached to the image projection apparatus;
a mover to move the base in a movement direction; and
a rotator including:
a mount to mount the base attached to the image projection apparatus; and
an imaginary rotation axis perpendicular to a plane including the movement direction and the projection direction,
wherein the mount is rotatable about the imaginary rotation axis, and
the imaginary rotation axis passes through a region of the image projection apparatus mounted on the mount via the base.

15. The image projection system according to claim 14,
wherein the mover moves the mount in the movement direction to:
change a distance between the image projection apparatus and a projection surface onto which projection light is projected from the image projection apparatus.

16. The image projection system according to claim 15,
wherein the mover moves the mount in the movement direction along a direction of gravity to move the base attached to the image projection apparatus.

17. The image projection system according to claim 16,
wherein the mover moves the mount in a direction opposite to the direction of gravity to increase the distance.
